(19) United States
(12) Patent Application Publication
(10) Pub. No.: US 2006/0192734 A1
(43) Pub. Date: Aug. 31, 2006

(54) Spoke light compensation for motion artifact reduction

(76) Inventor: Donald Henry Willis, Indianapolis, IN (US)

Correspondence Address: THOMSON LICENSING INC., PATENT OPERATIONS, PO BOX 5312, PRINCETON, NJ, 08543-5312, US

(21) Appl. No.: 10/566,493

(22) PCT Filed: Jun. 4, 2004
(86) PCT No.: PCT/US04/17842

§ 371 Date: Jan. 30, 2006

Related U.S. Application Data
(60) Provisional application No. 60/491,100, filed on Jul. 30, 2003.

(51) Int. Cl. G09G 3/34

(52) U.S. Cl. 345/84

(57) ABSTRACT

A sequential color display system includes a color changer that causes each of a set of primary colors to appear on an imager that illuminates of each of a plurality of pixels on a display screen. A controller applies control signals to the imager to control the pixel brightness for each color. Each time t h e color changer transitions from one primary color to another, a spoke occurs, and mixed light of two colors will illuminate the imager. The controller causes the imager to use such spoke light when the brightness level for each color for the associated pixel exceeds a prescribed threshold. When making use of the spoke light, the controller alters the control signal to decrease brightness of at least one primary color in substantial time proximity to the occurrence of the spoke to compensate for the brightness increase caused by using the light during the spoke.

### CROSS REFERENCE TO RELATED APPLICATION

This application claims priority under 35 U.S.C. 119(e) to U.S. Provisional Patent Application Ser. No. 60/491,100, filed Jul. 30, 2003, the teachings of which are incorporated herein.

### TECHNICAL FIELD

This invention relates to technique for operating a sequential color display system, and more particularly, to a technique that reduces the severity of motion artifacts caused by compensating for brightness increases made during colors transitions.

### BACKGROUND ART

There presently exist television projection systems that utilize a type of semiconductor device known as a Digital Micromirror Device (DMD). A typical DMD comprises a plurality of individually movable micromirrors arranged in a rectangular array. Each micromirror pivots about limited arc, typically on the order of 10°-12° under the control of a corresponding driver cell that latches a bit therein. Upon the application of a previously latched “1” bit, the driver cell causes its associated micromirror to pivot to a first position. Conversely, the application of a previously latched “0” bit to the driver cell causes the driver cell to pivot its associated micromirror to a second position. By appropriately positioning the DMD between a light source and a projection lens, each individual micromirror of the DMD device, when pivoted by its corresponding driver cell to the first position, will reflect light from the light source through the lens and onto a display screen to illuminate an individual picture element (pixel) in the display. When pivoted to its second position, each micromirror reflects light away from the display screen, causing the corresponding pixel to appear dark. An example of such DMD device is the DMD of the DLP™ system available from Texas Instruments, Dallas Tex.

Present day television projection systems that incorporate a DMD of the type described control the brightness (illumination) of the individual pixels by controlling the interval during which the individual micromirrors remain “on” (i.e., pivoted to their first position), versus the interval during which the micromirrors remain “off” (i.e. pivoted to their second position), hereinafter referred to as the micromirror duty cycle. To that end, such present day DMD-type projection systems use pulse width modulation to control the pixel brightness by varying the duty cycle of each micromirror in accordance with the state of the pulses in a sequence of pulse width segments. Each pulse width segment comprises a string of pulses of different time duration. The actuation state of each pulse in a pulse width segment (i.e., whether each pulse is turned on or off) determines whether the micromirror remains on or off, respectively, for the duration of that pulse. In other words, the larger the sum of the total widths of the pulses in a pulse width segment that are turned on (actuated) during a picture interval, the longer the duty cycle of the micromirror associated with such pulses and the higher the pixel brightness during such interval.

In television projection systems utilizing such a DMD, the picture interval, i.e., the time between displaying successive images, depends on the selected television standard. The NTSC standard currently in use in the United States requires a picture interval of 1/60 second whereas certain European television standards employ a picture interval of 1/50 second. Present day DMD-type television projection systems typically provide a color display by projecting red, green, and blue images either simultaneously or in sequence during each picture interval. A typical sequential DMD-type projection system utilizes a color changer, typically in the form of a motor-driven color wheel, interposed in the light path of the DMD. The color wheel has a plurality of separate primary color windows, typically red, green and blue, so that during successive intervals, red, green, and blue light, respectively, falls on the DMD.

As described, the combination of the DMD and the color wheel implement a sequential color display. In order to minimize the color breakup artifact of the sequential display, the color sequence appears multiple times per incoming picture. Thus, the color wheel must change the DMD illumination color multiple times during each picture interval. For example, a DMD-type television set that changes the illumination color 12 times per picture interval will display each of three primary colors four times per incoming picture, thus yielding a so-called 4× display.

A “spoke” occurs when the light striking the DMD undergoes a transition from one color primary to the next color primary. Normally, the display does not utilize the light (i.e., the “spoke light”) associated with a spoke because one cannot easily make a saturated color with such “mixed” light. However, at least one current DMD-type system, (i.e., the Texas Instruments DLP system) has an option, referred to as “spoke light recapture” (SLR), which uses some spokes' light under certain conditions, making it possible for a white object to have a significantly greater peak brightness. The color constantly changes during each spoke. In order to obtain a consistent color rendition, a spoke is used in its entirety or not at all. Furthermore, the Texas Instruments supporting circuitry for their DMD makes use of three spokes of different colors at a time, or not at all. When used, a set of three spokes yield a large amount of added white light, typically about 8% of full non-spoke time light.

The Texas Instruments Digital Micromirror System adds spoke light above a prescribed brightness threshold, typically about 60% of full brightness. Below this threshold, spoke light remains unused. Thus, when the brightness increases from just below the threshold to a value equal to the threshold, the spokes become “actuated”, thus adding the spoke light. In order to not have a large discontinuity in the brightness characteristic, a corresponding reduction must occur in the non-spoke light so that the resultant incremental brightness increases on the order of one least-significant-bit (LSB). However, if the corresponding reduction occurs at very different time(s) in the picture period than that occupied by the actuated spokes, conditions become ripe for a severe motion-contouring artifact.

Thus, a need exists for a technique for placing the correct amount of compensating reduction in the non-spoke segments at the appropriate time for every spoke that is activated.

### BRIEF SUMMARY OF THE INVENTION

Briefly, in accordance with the present principles, there is provided a method for operating a sequential color display system that includes a color changer that causes each of a set of primary colors to illuminate an imager that controls the brightness of each of a plurality of pixels for each color. The method commences by applying to the imager control signals, each typically a sequence of pulse width segments, with each segment illuminating an associated pixel for a corresponding color at a brightness level in accordance with the state of the control signal. Each time the color changer transitions from one primary color to another, an interval (spoke) occurs, and mixed light of two colors will illuminate the imager. The light occurring during at least one set of spokes is used when the brightness level for at least one color for the associated pixel exceeds a prescribed threshold. When using the spoke light, an alteration occurs to the control signal to decrease brightness of the at least one primary color in substantial time proximity to the occurrence of a spoke to compensate for the brightness increase caused by using the light during that spoke. While the spoke light compensation technique of the present principles can advantageously be used in a DMD system that employs pulse width modulation, the technique will find application in other types of sequential display systems.

### BRIEF DESCRIPTION OF THE DRAWINGS

FIG. 1 depicts a block schematic diagram of a sequential color display system for practicing the spoke light compensation technique of the present principles;

FIG. 2 depicts a frontal view of a color wheel comprising part of the display system of FIG. 1;

FIG. 3 depicts a table describing a set of bit planes that control the pulses within each pulse width segment driving an imager in the system of FIG. 1;

FIGS. 4-8 collectively illustrate an enumeration table of the bit planes that control the pulse width segments that manage the brightness of a corresponding color of each pixel within the display system of FIG. 1;

FIG. 9 depicts the light distribution among pulse width segments for a brightness level below which the spokes of a first set remain de-actuated;

FIG. 10 depicts the light distribution among pulse width segment for a brightness level at which the first set of spokes become actuated; and

FIG. 11 depicts a characteristic curve of light output as a function of the light input showing the influence of non-spoke light and spoke light.

### DETAILED DESCRIPTION

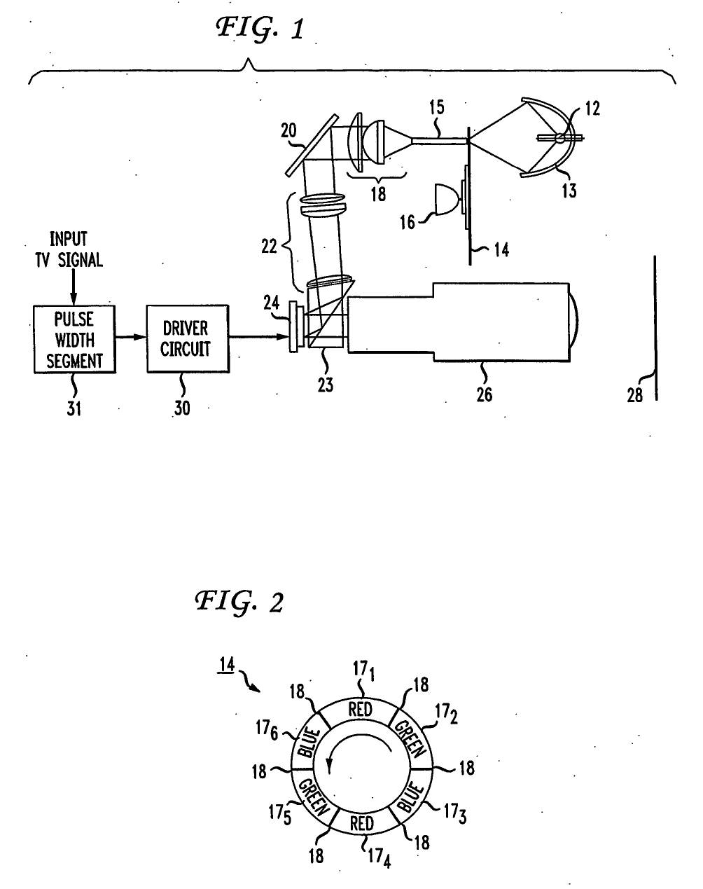

FIG. 1 depicts a sequential color display system 10 of the type disclosed in the Application Report “Single Panel DLP™ Projection System Optics” published by Texas Instruments, June 2001 suitable for practicing the spoke light compensation technique of the present principles. The system 10 comprises a lamp 12 situated at the focus of an elliptic reflector 13 that reflects light from the lamp through a color changer 14 and into an integrator rod 15. As described in greater detail below, the color changer 14 serves to sequentially place each of three primary colors, typically red, green and blue primary color windows, between the lamp 12 and the integrator rod 15. In the illustrated embodiment, the color changer 14 takes the form of a color wheel rotated by a motor 16. Referring to FIG. 2, the color wheel 14 in the illustrated embodiment has diametrically opposed red, green and blue color windows 17₁ and 17₄, 17₂ and 17₅, and 17₃ and 17₆, respectively. Thus, as the motor 16 rotates the color wheel 14 of FIG. 2 in a clockwise direction, blue, green and red light will strike the integrator rod 15 of FIG. 1 in sequence. In practice, the motor 16 rotates the color wheel 14 at a sufficiently high speed so that during a picture interval of a 1/60 second, blue, green and red light each strikes the integrator rod four times, yielding twelve color images within the picture interval, four red, four green and four blue that are interleaved, in a BGR sequence.

Referring to FIG. 1, the integrator rod 15 gathers the incident light at one end to yield at the other end a region of light of uniform cross-section that strikes a set of relay optics 18. The relay optics 18 spreads the light into a plurality of parallel beams that strike a fold mirror 20, which reflects the beams through a set of lenses 22 and onto a Total Internal Reflectance (TIR) prism 23. The TIR prism 23 reflects the parallel light beams onto a Digital Mirror Device (DMD) 24, such as the DMD device manufactured by Texas Instruments, for selective reflection into a projection lens 26 and onto a screen 28. Although the color wheel 14 appears in FIG. 1 within that portion of the optical path lying between the lamp 12 and the integrator rod 15, the color wheel 14 could reside anywhere in the optical path between the lamp and the display screen 28.

The DMD 24 takes the form of a semiconductor device having a plurality of individual micromirrors (not shown) arranged in an array. By way of example, the DMD manufactured and sold by Texas Instruments has a micromirror array of 1280 columns by 720 rows, yielding 921,600 pixels in the resultant picture projected onto the screen 28. Other DMDs could have a different arrangement of micromirrors. As discussed previously, each micromirror in the DMD pivots about a limited arc under the control of a corresponding driver cell (not shown) in response to the state of a binary bit previously latched in the driver cell. Each micromirror rotates to one of a first and a second position depending on whether the latched bit applied to the driver cell, is a “1” or a “0”, respectively. When pivoted to its first position, each micromirror reflects light into the lens 26 and onto the screen 28 to illuminate a corresponding pixel. While each micromirror remains pivoted to its second position, the corresponding pixel appears dark. The time during the picture interval while each micromirror reflects light through the projection lens 26 and onto the screen 28 (the micromirror duty cycle) determines the pixel brightness.

The individual driver cells in the DMD 24 receive drive signals from a driver circuit 30 of a type well known in the art and exemplified by the circuitry described in the paper “High Definition Display System Based on Micromirror Device”, R. J. Grove et al. International Workshop on HDTV (October 1994). The driver circuit 30 generates the drive signals for the driver cells in the DMD 24 in accordance with control signals, typically, in the form of sequences of pulse width segments applied to the driver circuit by a processor 31. Each pulse width segment comprises a string of pulses of different time duration, the state of each pulse determining whether the micromirror remains on or off for the duration of that pulse. The shortest possible pulse (i.e., a 1-pulse) that can occur within a pulse width segment (some times referred to as a Least Significant Bit or LSB) typically has a 15-microsecond duration, whereas the larger pulses in the segment each have a duration that is larger than one LSB. In practice, each pulse within a pulse width segment is controlled by a bit (hereinafter described as a “pixel control” bit) within a digital bit stream whose state determines whether the corresponding pulse is turned on or off. A “1” bit produces a pulse that is turned on, whereas a “0” bit produces a pulse that is turned off. The total sum (duration) of the actuated pulses in a pulse width segment controls the brightness of a corresponding pixel during that segment. Thus, the greater the combined pulse width (as measured in LSBs) of the actuated pulses in a pulse width segment, the greater the pixel brightness contribution for that segment.

For a 4× display, the driver circuit 31 generates each of four separate pulse width segments per color for every pixel. Thus, during each picture interval, the driver circuit 31 generates pixel control bits for the pulses of twelve segments, four red, four blue and four green. The transmission of the pixel control bits to the DMD 24 occur in synchronism with the rotation of the color wheel 14 so that each segment for a given color corresponds to the illumination of that color on the DMD 24.

Referring to the color wheel 14 of FIG. 2, a spoke 18 lies between each pair of different color windows, such as between the red window 171 and the green window 172. The number of spokes 18 will depend on the number of red, green and blue windows in the color wheel 14. Thus, the color wheel 14 of FIG. 2, which has two BGR color triplets (i.e., two sets of blue, green and red windows), will have six spokes 18. In the illustrated embodiment, the color wheel 14 rotates twice during each picture interval, giving rise to the appearance of twelve spokes during such time. Each spoke 18, when passing the spot of light from the lamp 12, yields an interval when the light is mixed, that is when the light contains a mixture of two different colors. For example, the spoke 18 lying between a blue and a green window will give rise to an interval of cyan. The spoke 18 lying between a red and a blue window will give rise to an interval of magenta. The spoke 18 lying between a red and a green window will give rise to an interval of yellow. In the past, DMD-type projection systems did not use light during a spoke (hereinafter referred to as “spoke light”) because of the difficulty arising in making a saturated color from such “mixed light.”

Presently, the Texas Instruments DMD system has an option referred to as “spoke light recapture” (SLR), which, under certain conditions, uses some spokes' light, making it possible for a white object to have significantly greater peak brightness. Since the color during each spoke constantly changes, in order to obtain a consistent color rendition, a spoke is used in its entirety or not at all. Furthermore, the Texas Instruments supporting circuitry for their DMD makes use of three spokes of different colors in combination, or not at all. Using a set of three spokes will give rise to an increased amount of added white light, typically about 8% of full non-spoke time light. Such light is added at a threshold bri ess, typically at about 60% of full brightness. Below this threshold, spoke light remains unused. Thus, when the brightness increases from just below the threshold to a value equal to the threshold, one set of spokes become actuated. In order to not have a large discontinuity in the brightness characteristic, a corresponding reduction should occur in the non-spoke light so that the resultant incremental brightness increases on the order of one least-significant-bit (LSB). If the corresponding reduction occurs at a very different time(s) in the picture period than that occupied by the turned-on spokes, then conditions become ripe for a severe motion-contouring artifact. A motion artifact can occur when a moving object has adjacent brightness portions just above and below the spoke light actuation threshold.

In accordance with the present principles, there is provided a technique for reducing the severity of such motion artifacts. As described in greater detail below, the compensation technique of the present principles compensates for the increased brightness achieved when a spoke is “actuated”, (i.e., the spoke light for a specific spoke is used) by decreasing most of the pixel brightness in substantial time proximity to the occurrence of the spoke. The best results generally occur when these decreases in pixel brightness occur substantially in their entirety immediately before and after an actuated spoke. However, good compensation can be achieved even if the decreased pixel brightness doesn't entirely occur immediately before and after the actuated spoke, so long as most of the brightness decrease occurs in substantial time proximity to the spoke actuation.

To understand the spoke light compensation technique of the present principles, a brief discussion of the manner of controlling the DMD 24 in system 10 will prove useful. As discussed previously, the DMD 24 in the illustrated embodiment comprises an array of 921,600 micromirrors. The pixel control bits for the micromirrors reside in “bit planes”, each taking the form of a string of bits corresponding in length to the number of micromirrors. The bits of each bit plane are loaded into the DMD 24, and depending on whether the individual bits in each bit plane are logic “1s” determines whether each micromirror controlled by that bit will illuminate a corresponding pixel or not. In the illustrated embodiment, the system 10 uses fourteen bit planes, with each bit plane controlling one or more pulses within one or more of the pulse width segments. However, a larger or smaller number of bit planes are possible.

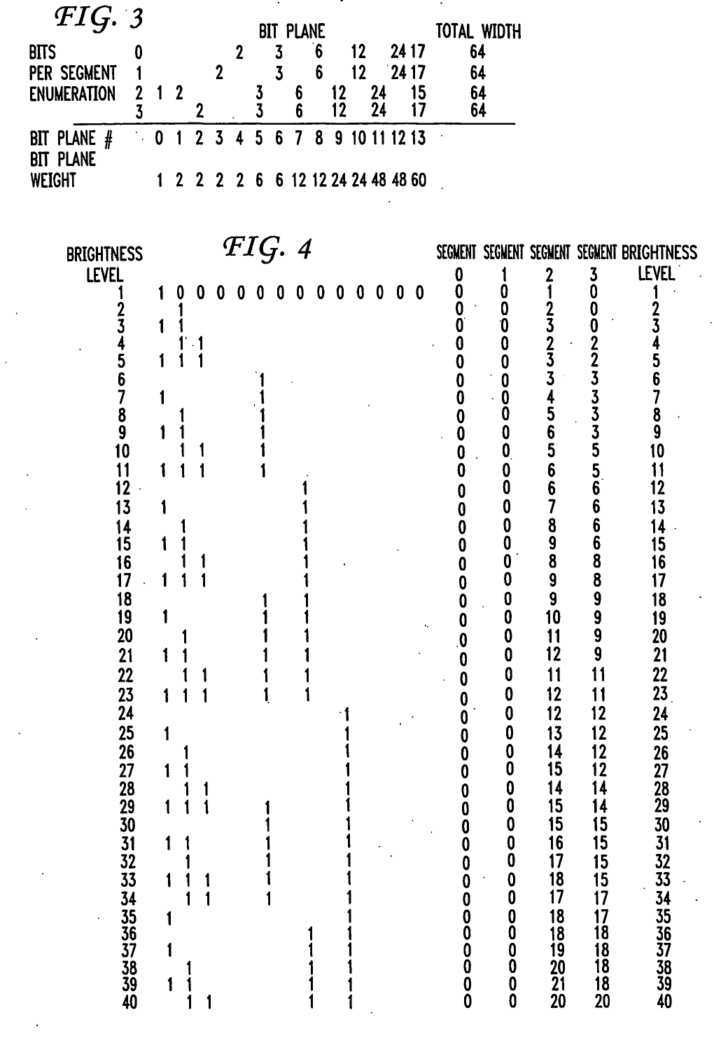

To understand how each bit plane controls the pulse(s) with the pulse width segments, refer to FIG. 3 that depicts a table showing for each bit plane, the expected weight distribution among pulses in the pulse width segments. The second to the last row in FIG. 3 identifies each of the fourteen bit planes, labeled as #0-#13, respectively, where as the last row in FIG. 3 lists the total weight (as measured in LSBs) for each bit plane. Thus, for example, bit plane #0 has a total weight of 1 LSB, whereas bit plane #13 has a total weight of 66 LSB. The first four rows of FIG. 3 show the expected weight distribution among the segments #0-#3 for each of the bit planes. For example, in the illustrated embodiment, bit plane #0 has a 1-LSB weight that is confined to segment #2. On the other hand, bit plane #5 has a total weight of 6 LSB with the expected distribution of 3 LSB in segment #2 and 3 LSB in segment #3. By comparison, bit plane# 13 has a total weight of 66 LSB with an expected distribution of 17, 17, 15 and 17 LSB in segments #0-#3, respectively. Note that while FIG. 3 depicts the expected distribution of the weight of each bit plane among the pulse width segments, the actual distribution can vary slightly. For example, for bit plane #9, the actual distribution between segments #2 and #3 could be 11.5 LSB and 12.5 LSB, respectively.

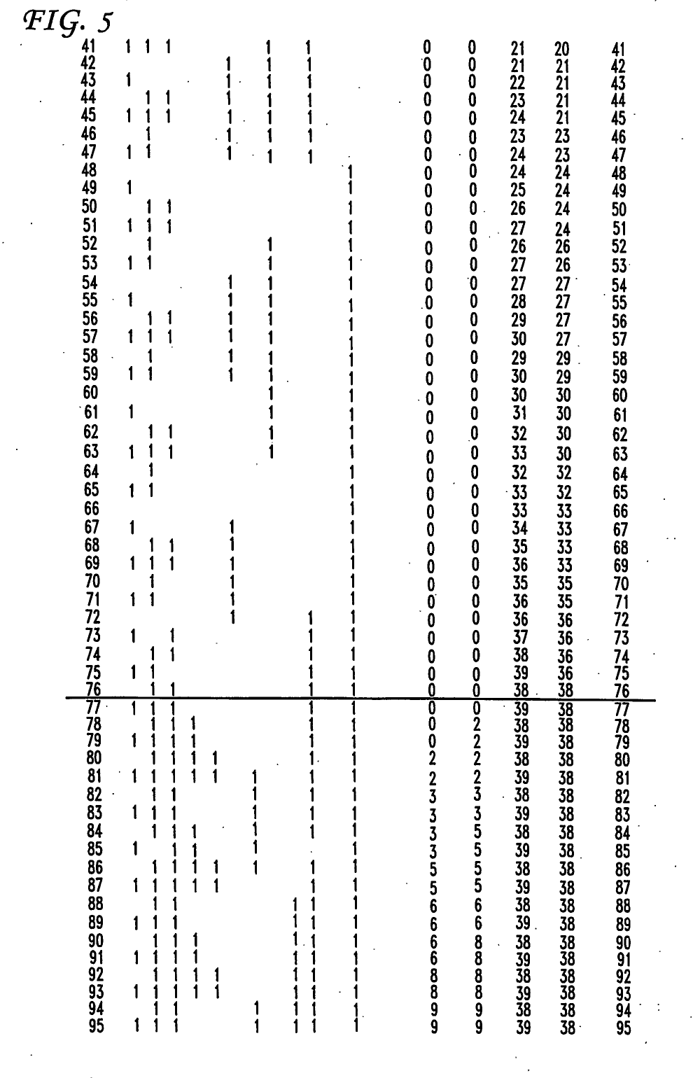

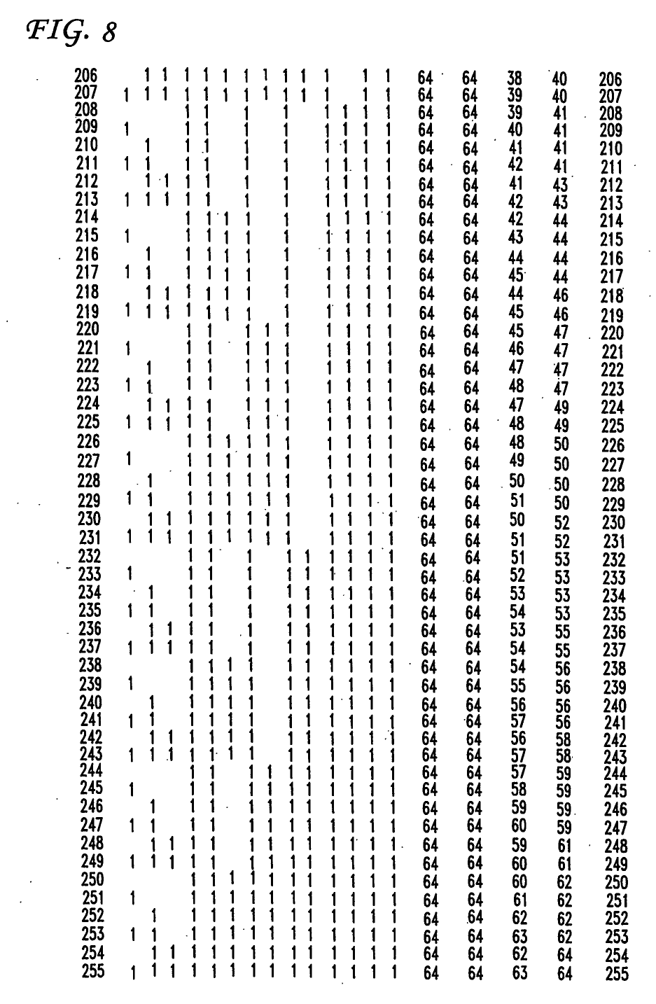

FIGS. 4-8 collectively depict a pulse width enumeration table whose values correspond to the particular bit plane(s) employed to control the pulses within a corresponding one of segments #0-#3, for each of brightness levels 0-255 for non-spoke light. Recall that each pulse width segment corresponds to a separate one of the four instances of a given color for an individual pixel during each picture interval (i.e., each 1/60th of a second). The pulse width enumeration values contained in tables of FIGS. 4-8 will achieve very good compensation upon actuation of a first and a second set of spokes, (hereinafter identified as spoke set #Ø and spoke set #1, respectively) at each of two different brightness levels, respectively, (e.g., brightness levels #150 and #203). Stated another way, the pulse width enumeration values contained in the tables of FIGS. 4-8 will provide very good spoke compensation when spoke actuation occurs in the following color order sequence [(B Ø G 1 R Ø ) (B 1 G Ø R 1) (B G R) (B G R)], with the spokes of sets #Ø and #1 represented as Ø and 1, respectively in the color order.

As will become better appreciated hereinafter, while the segments #0-#3 occur sequentially in time, segment #2 appears first in brightness followed segment #3 and then segments #1 and #0. In other words, segment #2 becomes incrementally brighter first as the brightness increases Segments #0 and #1 appear last in brightness, and undergo a decrease in brightness upon actuation of spoke set #Ø and #1 to compensate for the spoke light. Referring to FIG. 4, to achieve brightness level #1, the pulse controlled by plane #0 (having a 1-LSB width) becomes actuated in Segment #2, while the other pulses in this segment and in the other segments remain de-actuated.

To achieve brightness level #2, the pulse controlled by bit plane #1 (which has a 2-LSB width) becomes actuated, while the pulse controlled by plane #0 is now de-actuated during segment #2. As before, the other pulses in Segment #2 and the other segments remain de-actuated. To reach brightness level #3 , the pulse controlled by plane #0 (1 LSB) and the pulse controlled by plane #1 become actuated during segment #2 while the other pulses in Segment #2 and in the other segments remain de-actuated. To reach brightness level #4, the pulse controlled by plane # 1 remains during on while the pulse controlled by plane #0 remains off during segment #2. At the same time, the pulse controlled by plane #2 (2 LSB) becomes actuated during segment #3 with the other pulses in Segments #2 and 3 and in the other segments remain de-actuated. To achieve each of brightness levels #5-#77, the pulses controlled by other bit planes become actuated during each of segments #2 and #3 such that the total bit width (as measured in LSBs) corresponds to the desired brightness level. However, the pulses in segment #0 and segment #1 remain off at these brightness levels. To achieve a brightness level above brightness level #78 but below brightness level #206, the pulses controlled by the bit planes associated with segments #0 and #1 selectively become actuated. Between brightness levels 207-255, the pulses controlled by the bit planes associated with segments #0 and #1 become fully actuated. At brightness level #255 (the maximum brightness level), all the pulses controlled by the bit planes associated with segments #0-#3 become actuated to achieve a total 255 LSB pulse width.

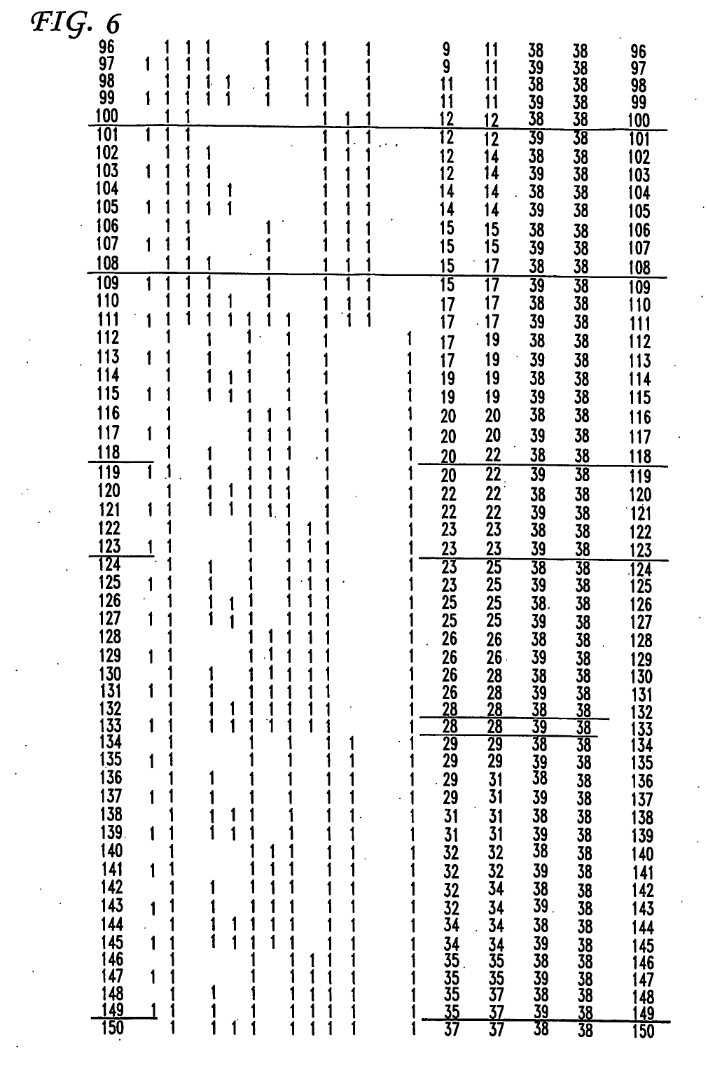

In the present embodiment, the spokes of spoke set #Ø becomes actuated when the brightness of at least one color, and typically when each of three primary colors, reaches a prescribed threshold, typically 60% of full brightness. In terms of the brightness levels depicted in the pulse width enumeration table of FIGS. 4-8, the spokes of spoke set #Ø becomes actuated when at least one color, and typically when each of the three primary colors has a brightness level above brightness level #149 in FIG. 6, assuming no color temperature adjustments. Thus, upon a transition from brightness level #149 to brightness level #150 for each color, the spokes of spoke set #Ø become actuated so that the added spoke light will increase the pixel brightness, as much as 8%. As an example, actuating the spokes of spoke set #Ø above brightness level #149 for the color red causes a brightness increase for that color.

To compensate for the spoke light arising from actuation of the spokes of spoke set #Ø, a corresponding brightness decrease should occur in the non-spoke light to enable a brightness increases on the order of a 1 LSB when transitioning from brightness level #149 to brightness level #150. In accordance with the present principles, compensation for the additional brightness attributed to the actuation of the spokes of spoke set #Ø for a given color (e.g., say red) occurs by selecting a corresponding value from the pulse width enumeration table of FIGS. 4-8 which has an associated brightness level that is reduced by nearly the same amount as the increased brightness associated with spoke actuation. This will become better understood with the following example. Assume a desired incremental brightness increase from brightness level #149 to brightness level #150 for the color red. Also assume that the spokes of spoke set #Ø become actuated above brightness level #149. Thus, to compensate for an additional 16 LSB brightness occurring from the actuation of the spokes, the pulse width segment associated with brightness level #134 is selected, rather than the pulse width segment associated with brightness level #150. The pulse width segment corresponding to brightness level #134 has a total pulse weight (as measured in LSBs) that is 16 less than the pulse weight associated with the pulse width segment associated with brightness level #150.

Using the pulse width enumeration values from table of FIGS. 4-8 to compensate for spoke light affords the advantage that the resultant reduction in brightness occurs substantially in very close time proximity to the occurrence of the spokes. Consider the pulse width enumeration value in the table of FIG. 6 for brightness level #134 chosen to compensate for the first set of spokes that become actuated at brightness level #150. The pulse width segment associated with brightness level #134 in FIG. 6 has segments #0, #1, #2 and #3 filled with pulses of total width 29, 29, 38 and 38 LSB, respectively. As compared to the segments #2 and #3 within the pulse width segment corresponding to brightness level #150, the segments #2 and #3 associated with brightness level #134 are each filled with pulses having the same total width (each 38 LSB). Only segments #0 and #1 of the pulse width segment enumeration table value associated with brightness level #134 have smaller total pulse widths (each 8 LSB less). However, adding the 16 LSB increase that arises from actuating the spokes of the first spoke set, to the 134 LSB brightness associated with brightness level #134 will yield a total pulse width of 150 LSB needed to reach the brightness corresponding to brightness level #150. Moreover, the lower pulse width values of segments #0 and #1 occur in their entirety in the time just before the first spoke of spoke set #Ø and just after the last spoke of spoke set #Ø, thus reducing the severity of motion contouring artifacts that otherwise would occur if the brightness decrease compensation occurred at a very different time relative to spoke actuation.

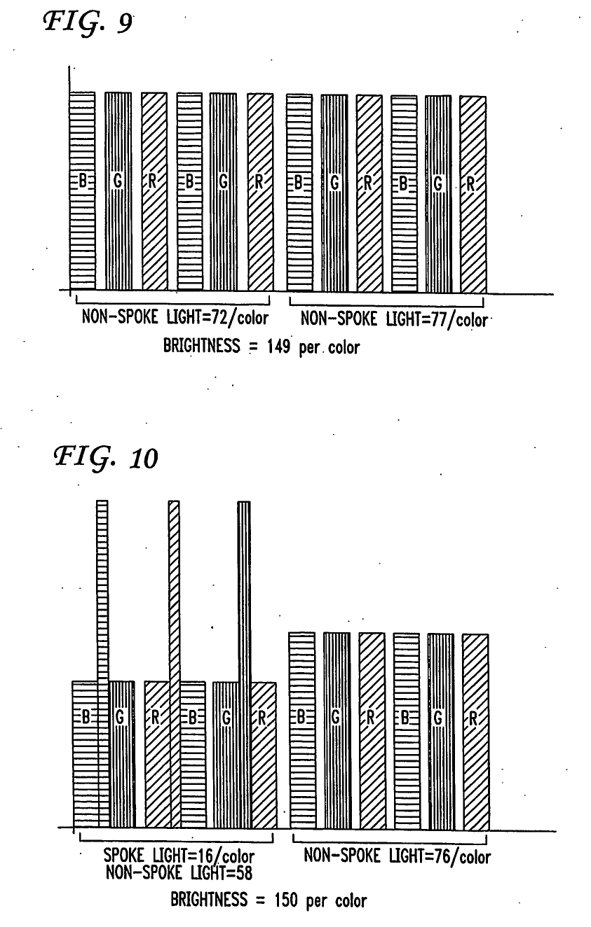

Reference to FIGS. 9 and 10 will help provide better understanding of how the brightness compensation in accordance with the present principles occurs substantially in very close time proximity to the spoke actuation. FIG. 9 illustrates the four color triplets (i.e., the four appearances of the colors blue, green and red) at a brightness level #149 for each color. The first and second color triplets (corresponding to segments #0 and #1, respectively) have a combined brightness of 72 LSB per color, which reflects the sum of the total bit weights of 35 LSB and 37 LSB associated with segments #0 and #1, respectively. By the same token, the third and fourth color triplets (corresponding to segments #2 and #3, respectively) have a combined brightness of 77 LSB per color, which reflects the sum of the total bit weights of 39 LSB and 38 LSB associated with segments #2 and #3, respectively.

FIG. 10 illustrates the four color triplets (i.e., the four appearances of the colors blue, green and red) at brightness level #150, along with the actuation of the spokes in spoke set #Ø. As seen in FIG. 10, a first spoke of spoke set #Ø appears between the first instances of the colors blue and green. A second spoke of spoke set #Ø appears between the first instance of red and the second instance of blue, whereas the third spoke of the same set appears between the second instance of green and the second instance of red. Compensating for the 16 LSB increase in light upon actuation of the spokes of spoke set #Ø by choosing the pulse width enumeration value corresponding to brightness level #134 from the table of FIG. 6 results in segments #0 and #1 having total bit weights of 29 LSB and 29 LSB respectively, whereas the segments #2 and #3 have total bit weights of 39 and 38, respectively.

As compared to the total pulse widths of the segments #0 and #1 associated with brightness level #150, the total pulse widths of the segments #0 and #1 associated with brightness level #134 are each 9 LSB less (28 LSB vs. 37 LSB). In contrast, segments #2 and #3 associated with the brightness level #134 have the same total pulse widths (39 LSB and 39 LSB) as compared to segments #2 and #3 associated with brightness level #150. When compensating for spoke light by utilizing the pulse width enumeration value of the table of FIG. 6 associated brightness level #134, each of the first two appearances of the colors blue, green and red associated with the segments. #0 and #1, respectively will have a reduced brightness.

As seen in FIG. 10, the reduction in brightness of the first appearances of blue and green appears just before and just after, respectively, the first spoke. Similarly, the reduction in brightness of the first appearance of red and the second appearance of blue occurs just before and just after, respectively, the second spoke. Further, the reduction in brightness of the second appearance of green and the second appearance of red occurs just before and just after, respectively, the third spoke. In other words, using the pulse width enumeration value from the table of FIG. 6 associated with brightness level #134 serves to confine substantially all the brightness reduction to the first two appearances of the colors blue, green, and red, which corresponds to the interval during which actuation of the spokes of spoke set Ø occurs. The third and fourth appearances of the colors blue green and red (corresponding to segments #2 and #3) have substantially the same brightness (excluding the incremental brightness increase that occurs upon reaching brightness level #150).

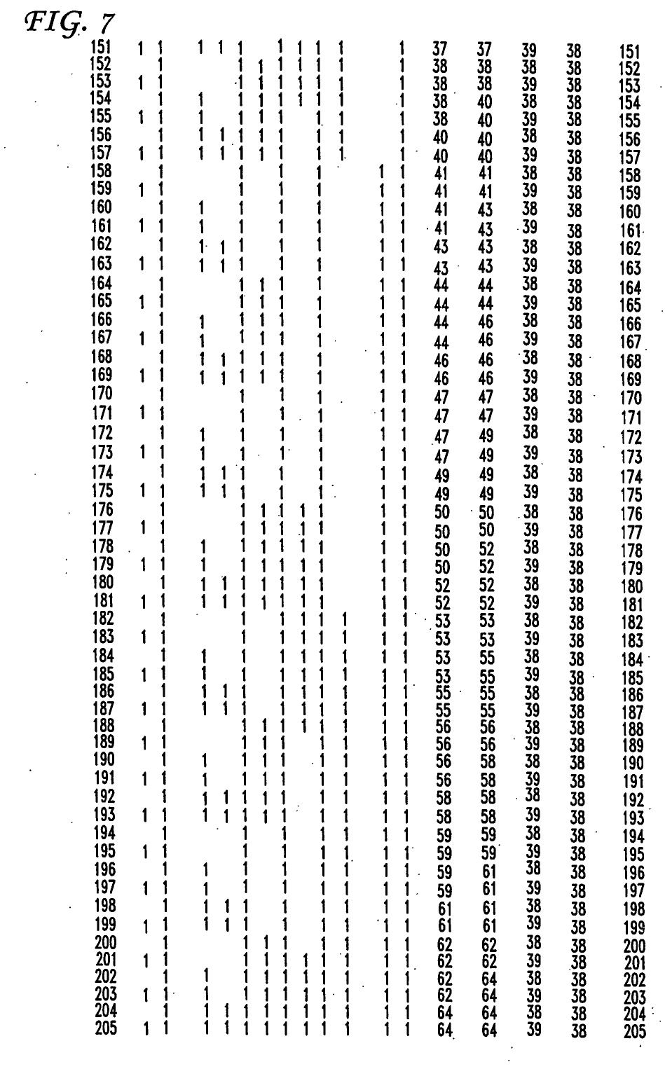

The system 10 of FIG. 1 also will compensate for an increase in spoke light when the spokes of a second spoke set (spoke set #1) become actuated above a second color brightness threshold, typically brightness level #203. To appreciate the manner in which the enumeration table of FIGS. 4-8 achieves spoke light compensation under such conditions, consider an incremental brightness increase from brightness level #203 to brightness level #204 for the color red. Also assume that the colors green and blue have a brightness level above the threshold for actuation of the spokes of spoke set #1. At brightness level #204, spoke set #1 becomes actuated (in addition to spoke set #Ø), giving rise to an increase in brightness for the color red, say by 16 LSB. Thus, to achieve an incremental brightness increase to brightness level #204 from brightness level #203, the pulse width enumeration value for the table of FIG. 7 associated with brightness level #188 is selected (rather than the pulse width segment enumeration value associated with brightness level #204).

Under non-spoke light conditions, the pulse width enumeration value in the table of FIG. 7 associated with brightness level 204 represents the actual value employed to obtain this brightness level. Thus, under non-spoke light conditions, the pulse width segments #0, #1, #2 and #3 associated with brightness level #204 will have total pulse widths of 64, 64, 39 and 38 LSB, respectively, that yield a total pulse width of 204 LSB. However, when using the spoke light associated with spoke set #Ø above brightness level #149, and when using the spoke light associated with the spoke of spoke set #Ø and #1 above brightness level #203, the pulse width enumeration table of FIGS. 6-8 does not actually represent the true state of affairs because of the need to use lower brightness level values to compensate for the spoke light. As discussed previously, a corresponding brightness decrease needs to occur in the non-spoke light to compensate for the spoke light, thus requiring the use of a lower brightness level value from the pulse width enumeration table of FIGS. 6-8 that affords the requisite brightness decrease, save the 1 LSB or so increase to incrementally increases brightness to the next higher level.

When transitioning from brightness level #203 to #204, the pulse width enumeration value in the table of FIG. 7 corresponding to brightness level #188 is employed (as opposed to the value associated with brightness level #204). As compared to the segments #2 and #3 associated with brightness level #204, segments #2 and # 3 associated with brightness level #188 have the same total pulse width (39 and 38 LSB, respectively). Only segments #0 and #1 associated with brightness level #188 have smaller widths (each 8 LSB less). However, adding the 16 LSB brightness increase that arises from actuating the spokes to the total 188 LSB width of segments #0, #1, #2 and #3 associated with the brightness level #188 will yield the requisite pulse width (204 LSB) to achieve the desired incremental increase in brightness to reach brightness level# 204 from level #203. As before, the lower pulse width values of segments #0 and #1 associated with brightness level #174 cause a brightness decrease for the color red that occurs in substantial time proximity to the corresponding spokes of the spoke set #1.

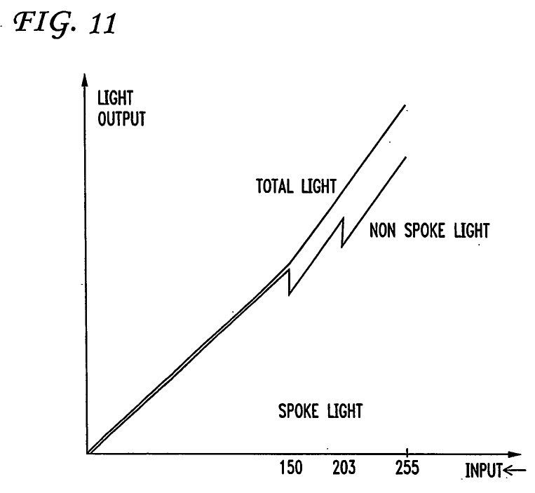

To better appreciate the contribution of spoke light to total light output, refer to FIG. 11 which depicts a graph of the total light output as a function on non-spoke light and spoke light. Prior to reaching brightness level #150, the total light output comes from the non-spoke light. Between brightness levels #150 and #203, the total light includes a first fixed amount of spoke light (resulting from the actuation of the spokes of spoke set #Ø) and as well as an amount of non-spoke light that increases incrementally in a linear fashion to achieve a corresponding increase in total light. Once the spokes of spoke set # Ø become actuated at brightness level #150, the non-spoke light drops by nearly the same amount as the increase due to the spoke light, except for an incremental increase to reflect the increase in brightness from level #149 to #150. At brightness level #203 and above, the spokes of spoke set #1 become actuated (along with the spokes of spoke set #Ø), giving rise a second fixed amount of spoke light. Again, the non-spoke light decreases by an amount corresponding to the increase in spoke light, except for an incremental increase associated with the increase in brightness level.

As discussed above, the pulse width enumeration table of FIGS. 4-8 provides very good spoke light compensation under the circumstances when spoke actuation occurs during segments #0 and #1 of each pulse width segment. However, the spoke actuation pattern could differ from [(B Ø G 1 R Ø) (B 1 G Ø R 1) (B G R) (B G R)] and under such circumstances, a different set of bit planes and a different pulse width enumeration table become necessary, depending on where the spokes occur, and which spokes become actuated. However, to afford spoke light compensation in the manner described above, such a table must have entries which achieve an appropriate brightness decrease in substantial time proximity to the spoke occurrence to take into account the corresponding brightness increase due to spoke light use The foregoing describes a technique for achieving compensation for spoke light in a sequential color display system such that a decrease in non-spoke light occurs in substantial time proximity to the occurrence of a spoke to reduce the incidence of motion contouring artifacts. While the illustrated embodiment has been described in connection with a pulse-width modulated sequential color display system, spoke light compensation in accordance with the present principles can readily be achieved without using pulse width modulation, provided the reduction in non-spoke light occurs substantially in very close time proximity to the occurrence of the spokes.

1. A method for operating a sequential color display system including a color changer and an imager, which operate in combination to sequentially illuminate at least one pixel with each of a set primary colors, comprising the steps of:
applying a control signal to the imager to cause the imager to illuminate the at least one pixel for each primary color at a brightness level in accordance with the control signal;
using light occurring during at least one first spoke, corresponding to a first interval when the color changer transitions from one color to another, when the at least pixel has a brightness level above a first prescribed threshold for at least one color; and
altering the control signal when the light is used during such spoke to decrease brightness of at the least one color in substantial time proximity to the occurrence of the spoke to compensate for the brightness increase caused by using the light during such spoke.

2. The method according to claim 1 wherein the step of altering the control signal comprises the step of altering the control signal to decrease the brightness immediately before and after such spoke.

3. The method according to claim 2 wherein the first brightness threshold differs for each color.

4. The method according to claim 1 further comprising the step of using light occurring during at least one additional spoke, in addition to the light used during the at least one first spoke, when said at least one color has a brightness level above a second threshold.

5. The method according to claim 4 wherein the second brightness threshold differs for each color.

6. The method according to claim 1 wherein the step of applying the control signal includes applying a plurality of sequences of pulse width segments, each pulse width segment causing the imager to illuminate an associated pixel for each primary color at a brightness level in accordance with a total actuation of pulses within the pulse segment for such associated pixel.

7. A method for operating a sequential pulse width modulated display system having a color changer and an imager that operate in combination to sequentially illuminate at least one pixel for each of a set of primary colors, comprising the steps of:
applying a plurality of sequences of pulse width segments to the imager, each pulse width segment causing the imager to illuminate the at least one pixel for each primary color at a brightness level in accordance with the actuation state of pulses within the pulse segment for said at least one pixel;
using light occurring during at least one first spoke, corresponding to a first interval when the color changer transitions from one color to another, when said at least one pixel has a brightness for at least one color above a prescribed threshold; and
altering at least one sequence of pulse width segments when the light is used during the at least one first spoke to decrease brightness of at the least one color in substantial time proximity to the occurrence of the at least one first spoke to compensate for the brightness increase caused from using the light during the at least one first spoke.

8. The method according to claim 7 wherein the first brightness threshold differs for each color.

9. The method according to claim 7 further comprising the step of using the light occurring during at least one additional spoke, in addition to the light used during said at least one first spoke, when said at least one color has a brightness level above a second threshold.

10. The method according to claim 7 wherein the second brightness threshold differs for each color.

11. A method for operating a sequential pulse width modulated display system having a color changer which causes each of a set of primary colors to sequentially illuminate an imager which lights up each of a plurality of pixels for each primary color, comprising the steps of:
applying a plurality of sequences of pulse width segments to the imager, each pulse width segment causing the imager to illuminate each pixel for each primary color at a brightness level in accordance with the actuation state of pulses for each pixel within the pulse segment;
choosing at least one first spoke, corresponding to a first interval when the color changer transitions from one primary color to another primary color;
altering at least one sequence of pulse width segments above a prescribed pixel brightness level for at least one color to selectively increase pixel brightness by using light during the at least one first spoke and to decrease pixel brightness during the pulse width segments occurring substantially immediately before and after the at least one first spoke in order to compensate for the brightness increase from the spoke light.

12. The method according to claim 11 wherein the first brightness threshold differs for each color.

13. The method according to claim 11 further comprising the step of using the light occurring during at least one second spoke in addition to the light used during at least one first spoke when each color has a brightness level above a second threshold.

14. The method according to claim 13 wherein the second brightness threshold differs for each color.

15. A sequential color display system, comprising:
a light source;
an imager for directing light from the light source to selectively illuminate each of a plurality of pixels on a display screen;
a color changer for sequentially changing the color of the light illuminating each of the plurality of pixels, and
a controller for (a) applying a control signal to the imager to cause the imager to illuminate an associated pixel for each primary color at a brightness level in accordance with the control signal; (b) using light occurring during at least one first interval (spoke) in which the color changer transitions from one color to another when at least one color has a brightness level above a first prescribed threshold; and (c) altering the control signal when the light is used during the at least one first spoke to decrease the brightness of at least one primary color in substantial time proximity to the occurrence of the at least one first spoke to compensate for the brightness increase caused from using the light during said at least one first spoke.

16. The apparatus according to claim 15 wherein the controller alters the control signal to decrease the brightness immediately before and after said at least one first spoke.

17. The apparatus according to claim 15 wherein the first brightness threshold is different for each color.

18. The apparatus according to claim 15 wherein the controller makes use of the light occurring during at least one second spoke, in addition to the light used during at least one first spoke, when each color has a brightness level above a second threshold.

19. The apparatus according to claim 18 wherein the second brightness threshold is different for each color.

20. The apparatus according to claim 15 wherein the controller applies a plurality of sequences of pulse width segments, each pulse width segment causing the imager to illuminate an associated pixel for each primary color at a brightness level in accordance with the actuation state of pulses within the pulse segment for such associated pixel.
